(19) United States
(12) Patent Application Publication
(10) Pub. No.: US 2010/0106887 A1
(43) Pub. Date: Apr. 29, 2010

(54) FLASH PRESENTATION (FLAPRE) AUTHORING TOOL THAT CREATES FLASH PRESENTATIONS INDEPENDENT OF A FLASH SPECIFICATION

(75) Inventor: David Hertenstein, Carrollton, TX (US)

Correspondence Address: PATENTS ON DEMAND, P.A. - IBM CHA, 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 12/256,946

(22) Filed: Oct. 23, 2008

(51) Int. Cl. G06F 12/02

(52) U.S. Cl. 711/103; 711/E12.008

(57) ABSTRACT

A system for authoring a FLASH presentation can include a FLASH-based FLASH presentation (FLAPRE) authoring tool and a launching application. The FLAPRE authoring tool can be configured to create a specialized FLAPRE code file containing a user-created FLASH presentation. The specialized FLAPRE code file can be created without the use of a FLASH specification. The launching application can be configured to present the FLASH-based FLAPRE authoring tool. The launching application can also support the use of FLASH animation.

### BACKGROUND

The present invention relates to the field of FLASH presentation authoring and, more particularly, to using an independent authoring tool to create FLASH presentations.

The use of FLASH animation has become a popular method for creating electronic presentations. However, creation of FLASH presentations typically requires users to have an understanding of and access to a FLASH authoring tool whose functionalities are based upon a FLASH specification. While software cost is generally not an issue for large corporations, it is often a prohibitive factor for small companies and/or individuals desiring to learn how to create FLASH presentations.

Another issue often encountered with conventional FLASH authoring tools is a lack of intuitiveness within the authoring process. Although conventional FLASH authoring tools include a graphical user interface (GUI), the user is still required to have an understanding of the configurable information being presented in the GUI. Since conventional FLASH authoring tools are based upon a FLASH specification, the information requested of the user is also based on the FLASH specification. Therefore, users of conventional FLASH authoring tools are required to have knowledge of the technical information contained within one or more FLASH specifications as well as awareness as to which FLASH specification is supported by the specific FLASH authoring tool.

For example, a user must understand how to define the motion of a content element in terms of coordinate values and/or vectors. Since users from a variety of backgrounds have the need to create FLASH presentations, a user interface that requires such technical knowledge is often frustrating.

Alternate FLASH authoring tools have been developed to provide a less technical GUI for users to utilize when creating FLASH presentations. However, some of these alternate FLASH authoring tools only provide a secondary interface to an existing conventional FLASH authoring tool, which simply increases the expense. Regardless, these alternate FLASH authoring tools are still based on or produce FLASH presentation files that conform to a FLASH specification. Thus, conventional FLASH authoring tools are unable to create FLASH presentations independent of a FLASH specification.

### BRIEF SUMMARY

One aspect of the present invention can include a system for authoring FLASH presentations. Such a system can include a FLASH-based FLASH presentation (FLAPRE) authoring tool and a launching application. The FLAPRE authoring tool can be configured to create a specialized FLAPRE code file containing a user-created FLASH presentation. The specialized FLAPRE code file can be created without the use of a FLASH specification. The launching application can be configured to present the FLASH-based FLAPRE authoring tool. The launching application can also support the use of FLASH animation.

Another aspect of the present invention can include a method for authoring FLASH presentations. Such a method can begin with an independent FLASH-based FLASH presentation (FLAPRE) authoring tool receiving user-entered data. The user-entered data can define a user-created FLASH presentation. The user-entered data can be unrelated to a FLASH specification. The user-entered data can then be translated into code elements of a specialized FLAPRE code file. The specialized FLAPRE code file can be stored in a user-designated location.

Yet another aspect of the present invention can include a FLASH-based FLASH presentation (FLAPRE) authoring tool. The FLAPRE authoring tool can include an interactive user interface, a FLAPRE code file generation engine, and a FLASH animation engine. The interactive user interface can be configured to provide an interaction mechanism for producing a user-created FLASH presentation. The interactive user interface can visually present and collect user-entered data defining the user-created FLASH presentation. The user-entered data can include content elements and corresponding format definitions. The user-entered data can be unrelated to a FLASH specification. The FLAPRE code file generation engine can be configured to create a specialized FLAPRE code file representing the user-created FLASH presentation. The specialized code file can contain code elements that correspond to the user-entered data input into the interactive user interface. The FLASH animation engine can be configured to provide graphical animation of the user-created FLASH presentation within the interactive user interface.

### BRIEF DESCRIPTION OF THE SEVERAL VIEWS OF THE DRAWINGS

FIG. 1 is a schematic diagram illustrating a system that utilizes a stand-alone FLASH presentation (FLAPRE) authoring tool to create FLASH presentations in accordance with embodiments of the inventive arrangements disclosed herein.

FIG. 2 is a flow chart of methods that detail the relationship between user actions and actions performed by the FLAPRE authoring tool, respectively, in accordance with an embodiment of the inventive arrangements disclosed herein.

FIG. 3 is an illustration of a user interface for the FLAPRE authoring tool in accordance with an embodiment of the inventive arrangements disclosed herein.

### DETAILED DESCRIPTION OF THE INVENTION

The present invention discloses a FLASH-based FLASH presentation (FLAPRE) authoring tool that can create a specialized FLAPRE code file containing a FLASH presentation. The specialized FLAPRE code file can represent the contents of the FLASH presentation is a manner that is independent of FLASH specifications. The FLAPRE authoring tool can include an interactive user interface where a user can create the FLASH presentation, including the definition of FLASH animation. Additionally, the FLAPRE authoring tool can utilize a FLASH animation engine to allow the user to preview the FLASH presentation.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer usable storage medium having computer usable program code embodied in the medium. In one embodiment, the invention is implemented in software, which includes but is not limited to firmware, resident software, microcode, etc.

Furthermore, the invention can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. Examples of a computer readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer usable or computer readable medium can even include paper or another suitable medium upon which the program is printed, as the program can be electronically captured, for instance, via optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

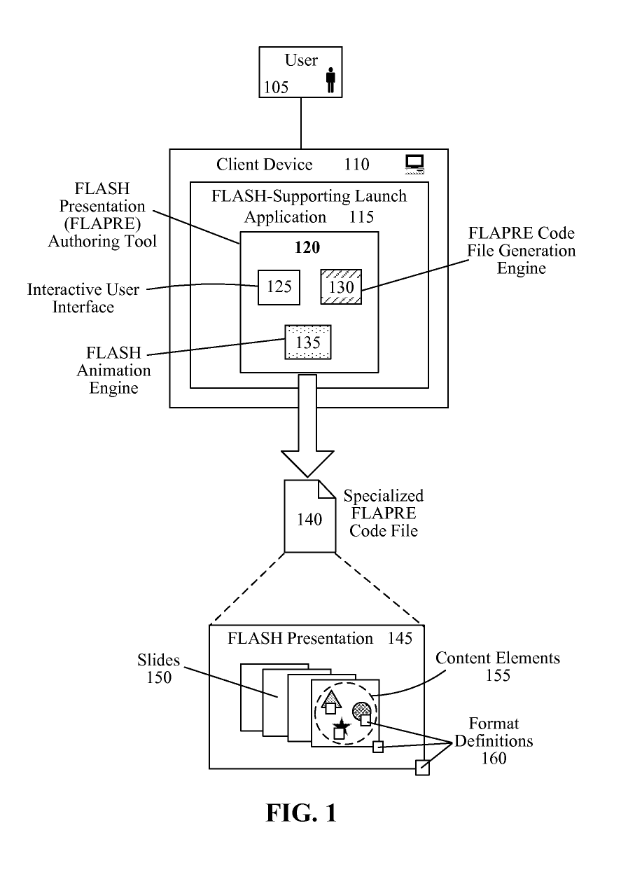

FIG. 1 is a schematic diagram illustrating a system 100 that utilizes a FLASH presentation (FLAPRE) authoring tool 120 to create FLASH presentations 145 in accordance with embodiments of the inventive arrangements disclosed herein. In system 100, a user 105 can utilize components of the FLASH presentation (FLAPRE) authoring tool 120, herein referred to as the FLAPRE authoring tool, operating on a client device 110 to create a FLASH presentation 145.

The client device 110 can represent a variety of electronic computing devices capable of executing the FLASH-supporting launch application 115. The FLASH-supporting launch application 115 can represent a software application capable of executing a FLASH file. For example, the FLASH-supporting launch application 115 can be a Web browser configured with an embedded FLASH PLAYER component. Alternately, the FLASH-supporting launch application 115 can be an independent software application, such as the ADOBE FLASH PLAYER.

The user 105 can utilize the FLASH-supporting launch application 115 to open the FLAPRE authoring tool 120. The FLAPRE authoring tool 120 can represent a FLASH software application configured to enable the user 105 to create a FLASH presentation 145. To perform this function, the FLAPRE authoring tool 120 can include an interactive user interface 125, a FLAPRE code file generation engine 130, and a FLASH animation engine 135.

It should be emphasized that the FLAPRE authoring tool 120 does not require access to any conventional FLASH authoring software. That is, the FLAPRE authoring tool 120 is not a secondary interface to an existing FLASH authoring application.

It should also be noted that since the FLAPRE authoring tool 120 is a FLASH application, usage of the FLAPRE authoring tool 120 is only limited by access to the FLASH-supporting launch application 115, which, similar to ADOBE FLASH PLAYER, is freely available.

The interactive user interface 125 can provide the user 105 with a graphical user-friendly mechanism for the creation of the FLASH presentation 145. The interactive user interface 125 can support a variety of user interface mechanisms, including, but not limited to, DRAG-AND-DROP, importation of files, keyboard entry, context menus, pull-down menus, creation wizards, templates, and the like.

The FLASH presentation 145 can represent an electronic compilation of one or more slides 150 used to visually present user-entered data. The data contained within the FLASH presentation 145 can be abstractly defined as a collection of various content elements 155, such as images, videos, or text strings. The behavior and/or appearance qualities of the content elements 155 can be conceptualized as format definitions 160 associated with the content elements 155. Format definitions can also be created for the overall FLASH presentation 145 and/or individual slides 150.

The data pertaining to content elements 155 and format definitions 160 can be added to the FLASH presentation 145 by the user 105 via the interactive user interface 125. For example, a user 105 can add text 155 to a slide 150 and can define the text 155 as a blue 18-point Arial font that spins every 30 seconds.

The data entered by the user 105 into the interactive user interface 125 to create the FLASH presentation 145 can be stored in a specialized FLAPRE code file 140 by the FLAPRE code file generation engine 130. The FLAPRE code file generation engine 130 can represent a software component of the FLAPRE authoring tool 120 configured to generate a specialized FLAPRE code file 140 from the data input into the interactive user interface 125 by the user 105.

The specialized FLAPRE code file 140 can correspond to an electronic file that contains specialized code elements representing the FLASH presentation 145. The format and/or syntax of the specialized FLAPRE code file 140 can be unrelated to a specification for a FLASH file (file extension of .SWF). For example, the specialized FLAPRE code file 140 can be based on an Extensible Markup Language (XML) whose structure, specialized tags, attributes, and values bear no relationship to those contained in the SWF file format specification.

It should be emphasized that the FLASH presentation 145 created by the FLAPRE authoring tool 120 is not contained within a FLASH file. The specialized FLAPRE code file 140 does not have a file extension of .SWF, and, as such, is not capable of being rendered by conventional FLASH viewing applications.

The FLAPRE authoring tool 120 can utilize the FLASH animation engine 135 to provide the user 105 with a preview animation of the FLASH presentation 145. The FLASH animation engine 135 can represent a software component of the FLAPRE authoring tool 120 that can be configured to provide FLASH animation, such as the FUSE KIT. The animation of the FLASH presentation 145 can be viewed by the user 105 within the interactive user interface 125. Additionally, the FLASH animation engine 135 can provide interfaces within the interactive user interface 125 for the animation of content elements 155.

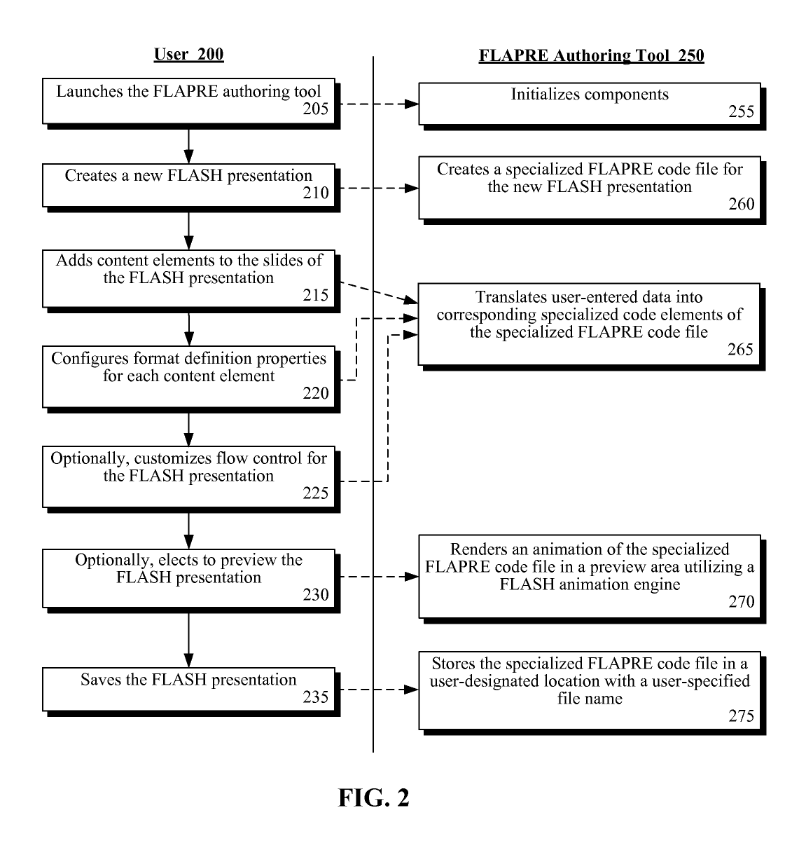

FIG. 2 is a flow chart of methods 200 and 250 that detail the relationship between user actions and actions performed by the FLAPRE authoring tool, respectively, in accordance with an embodiment of the inventive arrangements disclosed herein. Methods 200 and 250 can be performed in the context of system 100. Method 200 can represent actions performed by a user utilizing the FLAPRE authoring tool, while method 250 can express the actions initiated by the FLAPRE authoring tool in response.

Method 200 can begin with step 205 where the user can launch the FLAPRE authoring tool. In response, the FLAPRE authoring tool can execute step 255 where the FLAPRE authoring tool initializes its components.

In step 210, the user can execute a command to create a new FLASH presentation. In response, the FLAPRE authoring tool can execute step 260, creating a specialized FLAPRE code file for the new FLASH presentation.

The user can add content elements to the slides of the FLASH presentation in step 215. In step 220, the user can configure format definition properties for each content element. The user can optionally customize the flow control for the FLASH presentation in step 225. Flow control can represent the mechanism that controls the progression of the FLASH presentation.

In response to step 215, 220, and/or 225, the FLAPRE authoring tool can execute step 265. In step 265, the FLAPRE authoring tool can translate the user-entered data into the corresponding specialized code elements of the specialized FLAPRE code file.

The user can optionally elect to preview the FLASH presentation in step 230. Execution of step 230 can cause the FLAPRE authoring tool to execute step 270. In step 270, the FLAPRE authoring tool can render an animation of the specialized FLAPRE code file in a preview area utilizing a FLASH animation engine.

In step 235, the user can save the FLASH presentation. In response, the FLAPRE authoring tool can execute step 275, storing the specialized FLAPRE code file in a user-designated location with a user-specified file name.

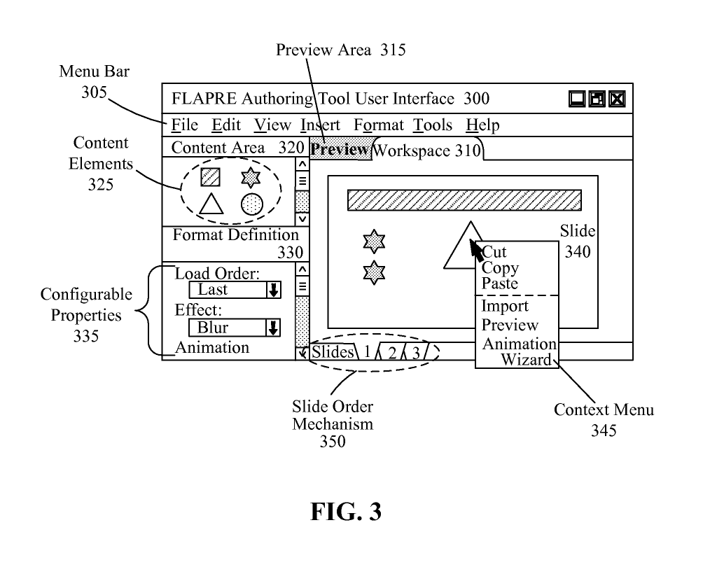

FIG. 3 is an illustration of a user interface 300 for the FLAPRE authoring tool in accordance with embodiments of the inventive arrangements disclosed herein. User interface 300 can represent the interactive user interface 125 of system 100 and/or handle related steps of method 200.

It should be noted that the FLAPRE authoring tool user interface 300 shown in FIG. 3 is for illustrative purposes only, and is not intended to represent a comprehensive embodiment. As such, additional components and/or configurations can be included without deviating from the spirit of the present disclosure.

User interface 300 can provide a user with an interactive mechanism for the creation of a FLASH presentation within the FLAPRE authoring tool. The user interface 300 can include a menu bar 305, a workspace area 310, a preview area 315, a content area 320, a format definition area 330, and a slide order mechanism 350.

Slides 340 of the FLASH presentation can be displayed in the workspace area 310. The user can add content elements 325 from the content area 320 to the slide 340 shown in the workspace area 310. For example, a content element 325 representing an image can be positioned on the slide 340 using a DRAG-AND-DROP behavior.

Additionally, content elements 325 can be imported from user-designated locations accessible by the user interface 300. As shown in this example, an import command can be selected from the context menu 345 of a content element 325. The user can then provide the location from which the FLAPRE authoring tool user interface 300 can import the data into the content element 325.

The user can be presented with a variety of configurable properties 335 in the format definition area 330 for a selected content element 325 in the workspace area 310. The configurable properties 335 can represent an assortment of behavior and/or appearance parameters, such as text size, coloring, filter effects, animation effects, presentation order, and the like. The configurable properties 335 can be entered into the format definition area 330 in various manners, such as the pull-down menus shown in this example.

Commands for the FLAPRE authoring tool can be executed within the user interface 300 via various mechanisms. The menu bar 305 can present the user with comprehensive and organized command lists. Context menus 345 can be utilized to provide command lists that are more specific to a selected content element 325 and/or slide 340. Additional pop-up windows (not shown) can be utilized to provide commands based on user actions.

Access to and the ordering of slides 340 within the user interface 300 can be controlled by a slide order mechanism 350. In this example, each 340 of the FLASH presentation is presented as a user-selectable tab within the slide order mechanism 350.

Additionally, the ordering displayed within the slide order mechanism 350 can correspond to the order in which the slides 340 will be animated within the FLASH presentation. The slide order mechanism 350 can include the capability for the user to modify the order of the slides 340 within the FLASH presentation.

The user can view animation of a specific slide 340 or the entire FLASH presentation within the preview area 315. As highlighted in this example, the preview pane 315 can be accessed by selecting its associated tab or menu command from the context menu 345. Access can be additionally provided by a menu command of the menu bar 305 or a button on a toolbar (not shown).

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for authoring FLASH presentations comprising:
a FLASH-based FLASH presentation (FLAPRE) authoring tool configured to create a specialized FLAPRE code file containing a user-created FLASH presentation, wherein said specialized FLAPRE code file is created independent of a FLASH specification; and
a launching application configured to present the FLASH-based FLAPRE authoring tool, wherein said launching application supports use of FLASH animation.

2. The system of claim 1, wherein the launching application comprises at least one of a FLASH-supporting Web browser and a software application designed to render FLASH files.

3. The system of claim 1, wherein the FLASH-based FLAPRE authoring tool further comprises:
an interactive user interface configured to provide an interaction mechanism for producing the user-created FLASH presentation, wherein said interactive user interface visually presents and collects a plurality of user-entered data defining the user-created FLASH presentation, wherein the plurality of user-entered data comprises at least a plurality of content elements and a plurality of format definitions corresponding to the plurality of content elements;
a FLAPRE code file generation engine configured to create the specialized FLAPRE code file from the plurality of user-entered data input into the interactive user interface; and
a FLASH animation engine configured to graphically animate the user-created FLASH presentation within the interactive user interface.

4. The system of claim 3, wherein the FLASH animation engine utilizes a FUSE KIT software application.

5. The system of claim 3, wherein the interactive user interface further comprises:
a workspace area configured to facilitate creation of the user-created FLASH presentation, wherein slides comprising the user-created FLASH presentation are presented within the workspace area;
a content element area configured to enable an addition of content elements to a slide of the user-created FLASH presentation;
a format definition area configured to visually present and collect a plurality of user-configurable properties for a user-selected content element, wherein said plurality of user-configurable properties define behavior and appearance qualities of the user-selected content element; and
a preview area configured to present a graphical animation of the user-created FLASH presentation as rendered by the FLASH animation engine.

6. The system of claim 3, wherein a content element comprises at least one of a textual element, an audio element, a video element, and an image element.

7. The system of claim 1, wherein the specialized FLAPRE code file is based upon an Extensible Markup Language (XML).

8. A method for authoring FLASH presentations comprising:
receiving a plurality of user-entered data by a FLASH-based FLASH presentation (FLAPRE) authoring tool, wherein said plurality of user-entered data defines a user-created FLASH presentation, and, wherein the plurality of user-entered data are unrelated to a FLASH specification;
translating the plurality of user-entered data into a plurality of code elements of a specialized FLAPRE code file; and
storing the specialized FLAPRE code file in a user-designated location.

9. The method of claim 8, wherein the plurality of user-entered data comprises at least a plurality of content elements and a plurality of format definitions corresponding to the plurality of content elements.

10. The method of claim 9, wherein a format definition represents a plurality of user-configurable properties for a content element, wherein said plurality of user-configurable properties define behavior and appearance qualities of the content element.

11. The method of claim 9, wherein a content element comprises at least one of a textual element, an audio element, a video element, and an image element.

12. The method of claim 9, wherein the specialized FLAPRE code file is based upon an Extensible Markup Language (XML).

13. The method of claim 8, further comprising:
receiving a user-selected command to preview the user-created FLASH presentation; and
presenting an animation of the user-created FLASH presentation in accordance with the plurality of user-entered data within a designated area of the FLASH-based FLAPRE authoring tool.

14. The method of claim 13, wherein the presenting of the animation of the user-created FLASH presentation utilizes a FLASH animation engine.

15. The method of claim 14, wherein the FLASH animation engine utilizes a FUSE KIT software application.

16. A FLASH-based FLASH presentation (FLAPRE) authoring tool comprising:
an interactive user interface configured to provide an interaction mechanism for producing a user-created FLASH presentation, wherein said interactive user interface visually presents and collects a plurality of user-entered data defining the user-created FLASH presentation, wherein the plurality of user-entered data comprises at least a plurality of content elements and a plurality of format definitions corresponding to the plurality of content elements, and, wherein the plurality of user-entered data are unrelated to a FLASH specification;
a FLAPRE code file generation engine configured to create a specialized FLAPRE code file representing the user-created FLASH presentation, wherein the specialized code file comprises a plurality of code elements corresponding to the plurality of user-entered data input into the interactive user interface; and
a FLASH animation engine configured to graphically animate the user-created FLASH presentation within the interactive user interface.

17. The FLAPRE authoring tool of claim 16, wherein the interactive user interface, FLAPRE code generation engine, and the FLASH animation engine are coupled in a FLASH software application.

18. The FLAPRE authoring tool of claim 16, wherein the FLASH animation engine utilizes a FUSE KIT software application.

19. The FLAPRE authoring tool of claim 16, wherein the interactive user interface further comprises:
a workspace area configured to facilitate creation of the user-created FLASH presentation, wherein slides comprising the user-created FLASH presentation are presented within the workspace area;
a content element area configured to visually present content elements for addition to a slide of the user-created FLASH presentation;
a format definition area configured to present a plurality of user-configurable properties for a user-selected content element, wherein said plurality of user-configurable properties define behavior and appearance qualities of the user-selected content element; and
a preview area configured to present a graphical animation of the user-created FLASH presentation as rendered by the FLASH animation engine.

20. The FLAPRE authoring tool of claim 16, wherein a content element comprises at least one of a textual element, an audio element, a video element, and an image element.

21. A computer program product for authoring FLASH presentations comprising a computer readable storage medium having computer usable program code embodied therewith, the computer usable program code comprising:
computer usable program code configured to receive a plurality of user-entered data by a FLASH-based FLASH presentation (FLAPRE) authoring tool, wherein said plurality of user-entered data defines a user-created FLASH presentation, and, wherein the plurality of user-entered data are unrelated to a FLASH specification;
computer usable program code configured to translate the plurality of user-entered data into a plurality of code elements of a specialized FLAPRE code file; and
computer usable program code configured to store the specialized FLAPRE code file in a user-designated location.

22. The computer program product of claim 21, further comprising:
computer usable program code configured to receive a user-selected command to preview the user-created FLASH presentation; and
computer usable program code configured to present an animation of the user-created FLASH presentation in accordance with the plurality of user-entered data within a designated area of the FLASH-based FLAPRE authoring tool.
